(19) United States
(12) Patent Application Publication
(10) Pub. No.: US 2008/0271651 A1
(43) Pub. Date: Nov. 6, 2008

(54) Secure System for Transporting or Preserving Valuables Such as Bank Notes

(76) Inventors: Thierry Sikora, Dijon (FR); Laurence Vohnout-Marle, Saint-Apollinaire (FR); Gerald Centrella, Belleneuve (FR); Lionel Riviere, Dijon (FR); Bruno Peltier, Saint Apollinaire (FR)

Correspondence Address: YOUNG & THOMPSON, 209 Madison Street, Suite 500, ALEXANDRIA, VA, 22314, US

(21) Appl. No.: 11/579,397

(22) PCT Filed: Apr. 19, 2005
(86) PCT No.: PCT/FR2005/00956

§ 371 Date: Apr. 2, 2008

(30) Foreign Application Priority Data
May 6, 2004 (FR) 0404919

(51) Int. Cl. E05G 1/14

(52) U.S. Cl. 109/25; 109/23

(57) ABSTRACT

A secure system for transport or preserving valuables, enclosed in a container (1) is provided with an internal controlling element (10) and a mechanism for deteriorating (20, 21) the valuables in case of attack. The system consists of at least one container (1) equipped with a memory card (9) reader (8) connected to internal control element (10) and at least one base (11) provided with an electronic map (12) wherein are recorded data concerning the location of the base (11) adapted to receive such that a user may use the container (1) either as a permanent safe for preserving valuables or for transporting the valuables from the fixed located base (11) at a starting point situated at the sender's (2) to a second base (11) at the recipient's (5).

This present invention concerns a secure system for the transportation or the conservation of valuables and in particular of banknotes, cheques, bank cards or similar enclosed in a container fitted with internal control resources and resources for damaging the said valuables in the event of attack.

In the area of secure systems for the transportation of banknotes, one is already familiar with systems that include a container fitted with damaging resources, more particularly of resources for staining the notes with an indelible ink. This is the case, for example, of European patent EP 0 409 725. This patent describes a system in which a container is fitted with internal control resources operating in the manner of a “limited modes machine” whose operating cycle includes a restricted number of logical states called “modes”, with the transition from a first mode to a second mode being the consequence of a one-off event whose legitimacy is, or has been, verified beforehand by an independent means that is capable of making contact with the said internal control resources of the container, with the said transition then being accompanied by the loss of memory of the prior mode. This system is intended to be used for the protection of funds placed in a container by a responsible person in a banking establishment, called the sender for example, in order to be transported by a carrier to a branch of this banking establishment, for example. The succession of the logical states of the container, and as a consequence, the transfer of the responsibility, is entrusted to a unique supervision computer in order to control the logical security of the containers, that is to verify the legitimacy of the transitions from certain operating modes of their internal control resources to certain other modes. Such a system is particularly well suited to all repetitive transfers of funds such as, for example, transfers between a bank and its various establishments. However, this system is not well suited to the transfer or the collection of funds in an occasional or temporary basis, for obvious reasons of cost. In fact, this system requires the installation of a special station at each collection site, which is particularly costly.

In order to remedy this drawback, a system has already been proposed for the secure transportation of objects in tamper-proof containers, of which at least one receiving station is mobile and transportable in order to allow the transfer or the collection of funds on an occasional or temporary basis. This is the case, for example, of French patent FR 2 751 111. This patent describes a secure system for the transportation of valuables enclosed in a container which, in the event of attack, causes them to be damaged. The container is fitted with internal control resources operating also in the manner of a “limited modes machine”, that is capable of including successively, totally or in part only, the elements of an assembly made up by a user of the valuables, meaning a sender, a recipient or a carrier, a container and a unique server centre located remotely, which is able to make contact with the internal control resources of the said container when it is at its place of departure. The user of the valuables, the container and the server centre are connected together by means of a unique terminal forming a station in a star network with the said station at its centre. In order to allow the transfer or the collection of funds in an occasional or temporary manner, the station of at least one recipient is not a resident station but rather a mobile and transportable station. This mobile station of the recipient is a terminal with a keyboard and screen fitted with a microprocessor and a fully independent memory card reader, that is not connected to the server centre and capable of being connected via a communication interface with the container, where the said interface advantageously possesses an energy source that can be used to power the terminal and the container, and in particular its electromagnetic lock.

Thus, the systems of previous design can be used to effect the transportation and the collection of valuables not only for repetitive transfers but also for occasional or temporary transfers. Nevertheless, these systems are not suitable for the conservation of valuables, and users are obliged to equip themselves with fixed safes in order to conserve their valuables at a fixed location, thus seriously increasing equipment costs.

One of the aims of the invention is therefore to remedy this drawback by proposing a secure system for the transportation or the conservation of valuables, in particular of banknotes, cheques, bank cards or similar, allowing the system to be used either in the manner of a permanent safe for the conservation of valuables, or for transportation of the said valuables from a site of departure to that of a recipient.

To this end, and in accordance with the invention, the proposal is for a secure system for the transportation or the conservation of valuables, in particular of banknotes, cheques, bank cards or similar, enclosed in a container fitted with internal control resources and resources for damaging the valuables in the event of attack, with the said internal control resources operating, for example, in the manner of a “limited modes machine” whose operating cycle includes a restricted number of logical states, called modes, with the transition from a first mode to a second mode being the result of a one-off event whose legitimacy is, or has been, verified beforehand by a server centre located remotely, that is capable of making contact with the internal control resources of the container by ant appropriate means, with the said transition then being accompanied by the loss of memory of the prior mode. The said system is notable in that it is composed firstly of at least one container fitted with a memory card reader connected to the internal control resources, with the said memory card including at least one location identity code of the user of the containers, and secondly, of at least one base fitted with an electronic card, the said carte being powered by an energy source, in which are recorded data relating to the location of the said base which is suitable to receive the container fitted with a male or female connection resource connected to the internal control resources mating with a complementary male or female connection resource connected to the electronic card of the base so that a user is able to use the container either in the manner of a permanent safe for the conservation of valuables, so that, in order to open and close the container, he inserts the memory card into the card reader of the said container, which is then positioned on the base, with the opening and closure of the container being possible only if the data relating to the location of the base are in agreement with the data recorded in the memory card and or the resources for the internal control of the container, or for transportation of the valuables from the localised fixed base at a point of departure to a second base located at the premises of the recipient.

Other advantages and characteristics will emerge more clearly from the description that follows of several execution variants, provided by way of non-limiting examples, of the secure system for the transportation or the conservation of valuables according to the invention, with reference to the appended drawings in which:

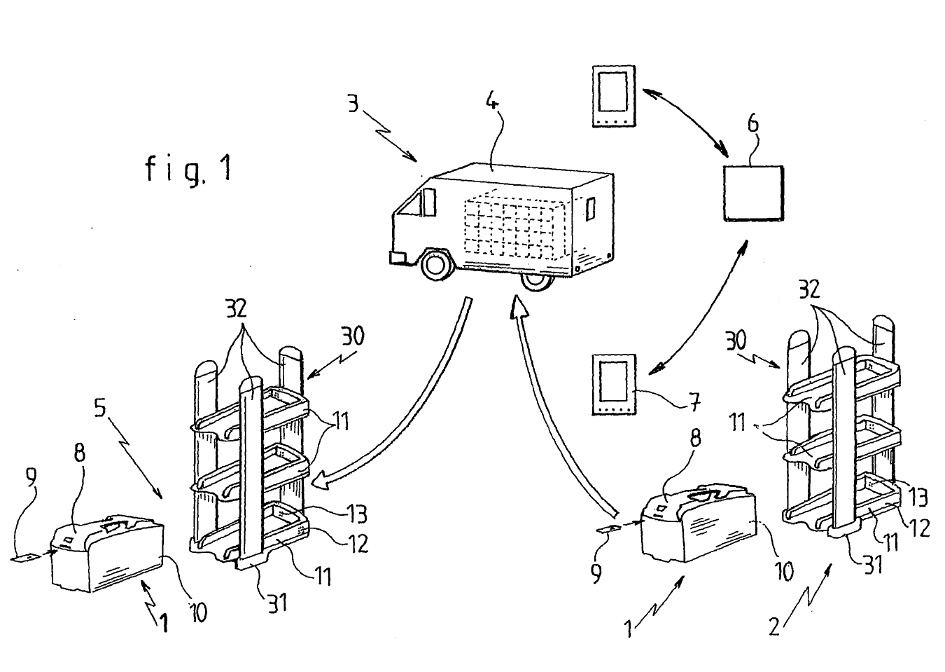

FIG. 1 is a block diagram of the organisation of the system according to the invention,

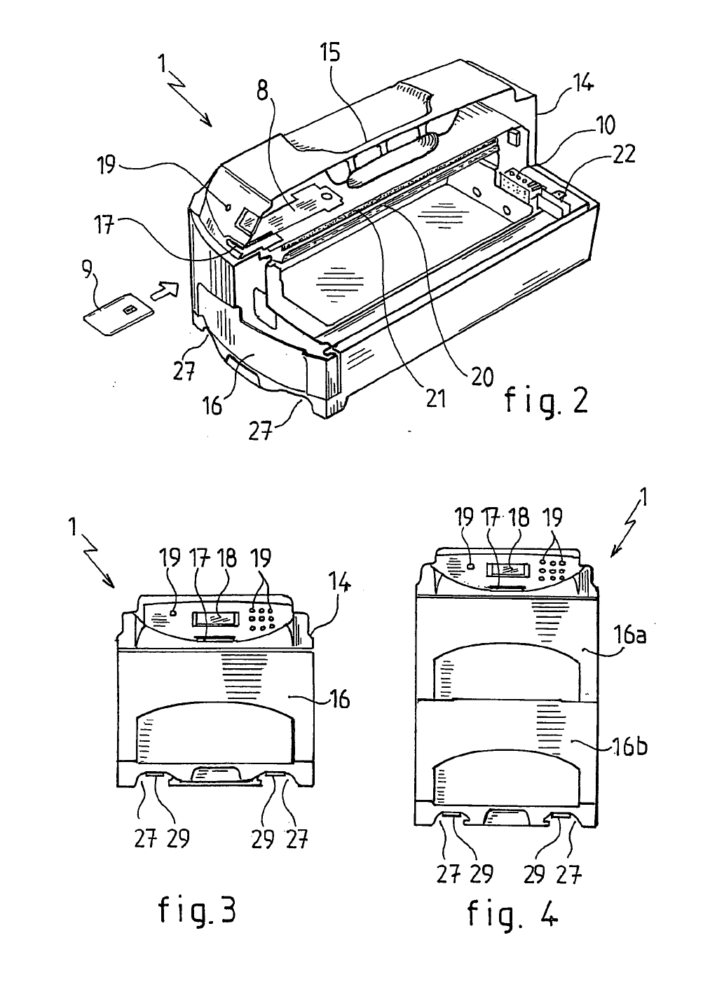

FIG. 2 is a view in cut-away perspective of a container of the system according to the invention,

FIG. 3 is a front view of the container according to the invention shown in FIG. 2,

FIG. 4 is a front view of an execution variant of the container according to the invention,

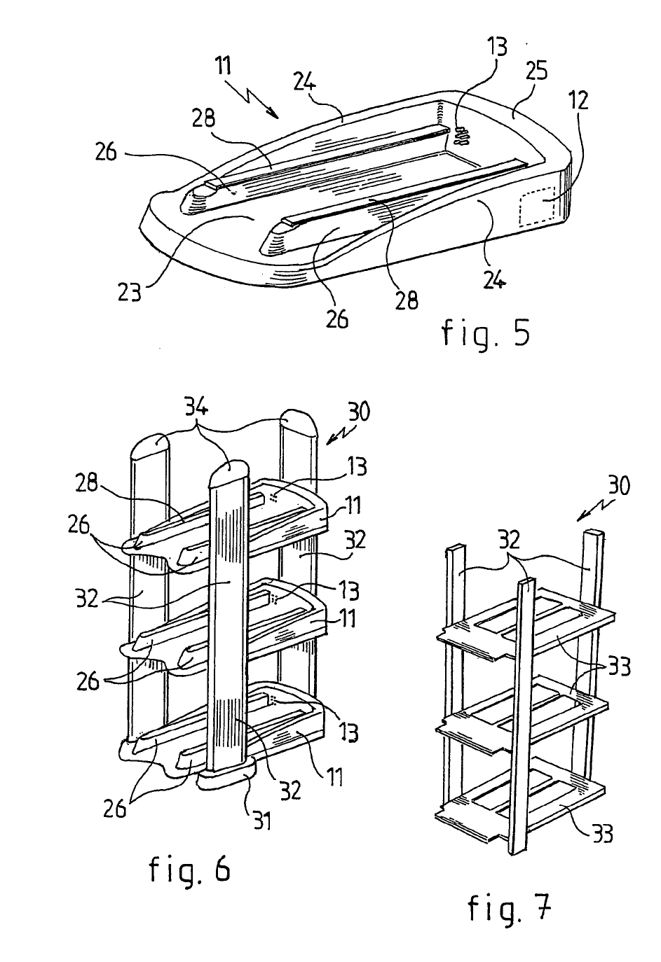

FIG. 5 is a view in perspective of a base designed to receive a container of the system according to the invention.

FIG. 6 is a view in perspective of a multiplicity of bases attached to a vertical modular structure,

FIG. 7 is a view in perspective of the uprights and the platforms supporting the vertical structure carrying the bases of the system according to the invention,

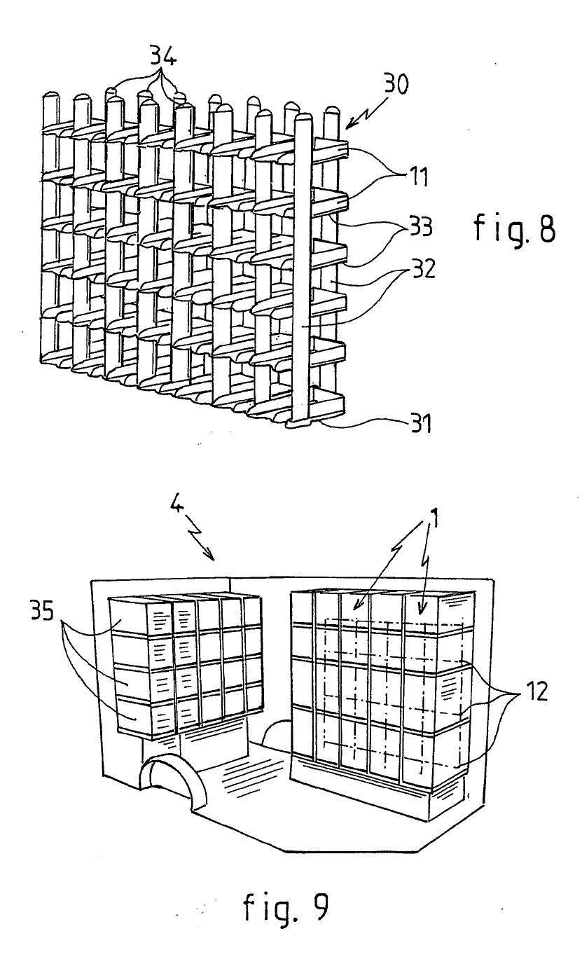

FIG. 8 is a view in perspective of an implementation variant that consists of a multiplicity of vertical structures attached to each other,

FIG. 9 is a view in perspective of the interior of the vehicle, showing the compartments in which the containers are place during transportation.

A description will now be given of a particular example of use of the secure system for the transportation or the conservation of valuables according to the invention, between a central site such as a central bank and a single recipient such as a banking establishment. Nevertheless, it is quite obvious that this example is given only by way of a non-limiting illustration of the system according to the invention, which can include several recipients in particular.

Referring to FIG. 1, the system according to the invention is intended to protect valuables which have been placed in a container 1 in the central bank, which is the sender 2. The said container 1 filled with valuables is then transported by a carrier 3 by means of a vehicle 4 to the recipient 5, in this case a banking establishment.

It is quite obvious that all of the events preceding the transportation by the carrier 3 of the valuables which give rise to a number of transitions from one mode to another of the container 1 are in accordance with the description in European patent EP 0 409 725 and/or of French patent FR 2 751 111, and will not be described further here. Reference to the aforementioned patents is recommended for more detail on this. However the transitions from one mode to another, leading to transfers of responsibility for the container 1, are controlled by a server centre 6 which manages the logical security of the container 1 when it is at its place of departure at the premises of the sender 2. Thus, the server centre 6 verifies the legitimacy of the transitions from certain operating modes of the internal control resources of the container 1 to other operating modes. The said server centre 6 verifies legitimacy by communicating with a device 7 for programming and managing the containers 1, as will be described in more detail below.

Referring to FIGS. 1, 2 and 5, the system is composed of a container 1 fitted with a memory card 9 reader 8 connected to the internal control resources 10 of the container 1, with the said memory card 9 consisting preferably of a chip card which has in its memory at least one identity code of the user of the container 1, that is the recipient. The system also includes at least one base 11 fitted with an electronic card 12, with the said card 12 being powered by an energy source, in this case the conventional 230 V mains supply, in which are recorded data relating to the location of the said base 11 that is suitable to receive the container 1. The said container 1 is fitted with a male connection resource (not shown in the figures) connected to the internal control resources, mating with a complementary female connection resource 13 connected to the electronic card 12 of the base 11 so that a user can use the container 1 either in the manner of a permanent safe for the conservation of valuables, so that in order to open and close the container 1, he inserts the memory card 9 into the card reader 8 of the said container 1, which is then positioned on its base 11, where the opening and closure of the container 1 can be effected only if the data relating to the location of the base 11 are in agreement with the data recorded in the memory card 9 and/or in the internal control resources 10 of the container 1 or for the transportation of the valuables from the fixed base 11 of the sender 2 to the second fixed base 11 of the recipient 5.

In addition, the container 1 consists of a compartmented case 14, generally parallel-sided, equipped on its upper face with a carrying handle 15 and open at the front, so that at least one drawer 16 forming a compartment in which the valuables are placed is able to slide from a first closed position in which the said drawer 16 is located inside the compartmented case 14, to a second opening position in which the said drawer 16 is located totally or partially outside the said compartmented case 14. The drawer 16 and/or the compartmented case 14 includes anti-intrusion sensors (not shown in the figures), such as, for example, a sensor to check on the integrity of a wall, as described in French patent FR 2.615.987 from the applicant. These sensors are connected to the internal control resources of the container 1 in order, when any damage is detected by the sensors, to allow activation of the resources to damage the valuables, as will be seen later.

Referring to FIGS. 2 and 3, the container 1 includes, on its front side, a slot 17 for insertion of the memory card 9, located above the drawer 16, with the memory card 9 reader 8 connected to the internal control resources 10 opposite to slot 17 inside the compartmented case 14. The container 1 also includes, on its front side, a display screen 18 and control buttons 19 connected to the internal control resources 10 of the said container 1 and located above the slot 17 for insertion of the memory card 9.

According to an execution variant of the container of the system according to the invention, the said container 1 consists of a compartmented case 14, generally parallel-sided, preferably fitted on its upper wall of a carrying handle 15 and open at the front so that two drawers 16a, 16b forming two superimposed compartments in which the valuables are placed, are able to slide from a first closed position in which the said drawers 16a, 16b are located inside the compartmented case 14, to a second opening position in which the said drawers 16a, 16b are located totally or partially outside the said compartmented case 14. It can be seen that the upper drawer 16a can open independently of the lower drawer 16b and vice versa.

It goes without saying that the container 1 can include more than two drawers 16 without however moving outside the scope of the invention. Referring to FIG. 2, the resources for damaging the valuables, controlled by the internal control resources 10 on the occasion of damage to the container 1 consist of flexible pockets 20 filled with an indelible ink placed in the compartmented case 14 so that they are located above the valuables when the drawer 16 is closed. These flexible pockets 20 are designed to be torn by pyrotechnic resources 21 activated by the internal control resources 10 of the container 1 in the event of an attack. In a particularly advantageous manner, in order to achieve perfect tracability of the notes after they have been stained, a DNA tracer, as described in international patent application WO 02/090581 for example, is mixed with the indelible ink contained in the flexible pockets 20, with the ink in each container 1 including a specific DNA tracer that can be used later to ascertain the container 1 that has been subject to damage and which has stained the valuables.

In addition, referring to FIG. 2, each container 1 includes a recording unit 22, called a black box, in which all the operations effected on the container 1 between the base of departure 11 of the sender and the base 11 of arrival of the recipient. This recording unit 22 consists, for example, of an electronic memory component (EPROM—Erasable programmable read only memory). The data saved in the recording unit 22 are totally erased when the container 1 is positioned on the arrival base at the premises of the recipient.

Referring to FIG. 5, the base 11 is composed of a rectangular horizontal plate 23 fitted with two longitudinal walls 24 and a lateral wall 25 forming the rear part of the said base 11. The horizontal plate 23 includes, on its upper face, two parallel longitudinal rails 26 fitting into two complementary parallel longitudinal grooves 27 located under the compartmented case 14 of the container 1 (see also FIG. 3). The said rails 26 include on their respective top ends a longitudinal contact 28 that bears against a stud 29, positioned respectively at the bottom of the grooves 27 of the compartmented case 14, with the contacts 28 and the studs 29 being connected to the energy source of the base to the power source of the internal control resources 10 of the container 1 (see also FIG. 2) respectively. It can be seen that the contacts 28 are held up against the studs 29 when the container 1 is positioned on its base 11 by means of resilient resources (not shown in the figures). In addition, the power source of the internal control resources 10, which is not shown FIG. 5, consists of a rechargeable battery that is well known to the professional engineer.

In a minimal version, the system can have only a single base 11 at the departure site and a single base 11 at the arrival site of the containers 1. Nevertheless, banking activities usually require the use of several containers 1 and therefore of several bases 11.

In this regard, referring to FIGS. 1 and 6, the system can advantageously include a multiplicity of bases 11 attached to at least one vertical modular structure 30 that includes a generally rectangular horizontal base 31 onto which a first base 11 bears, and from which extend three uprights 32 from the longitudinal walls 24 and the lateral wall 25 of the first base 11, with horizontal support platforms 33 (FIG. 7) respectively capable of receiving a base 11, being fixed onto these uprights 32. It can be seen that the said support platforms 33 are positioned at regular intervals, with the distance separating two consecutive platforms 33 being just greater than the height of a container 1, and providing good rigidity to the vertical structure 30. The uprights 32 consist of tubular elements whose end are designed to fit into lugs extending from the upper face of the base 31 or from connecting pieces, according to the height of the support structure 30 required. In order to prevent injury, the top ends of the uprights 32 include parts 34 made of a plastic material fitting onto the ends of the said uprights 32.

Referring to FIG. 8, in an execution variant of the system according to the invention, several vertical frame structures 30 as described above, can be joined in pairs for example. It is then possible to modulate the number of bases 11 to suit the activity of the customer.

Referring to FIG. 1, the system includes a device 7 for programming and control of the containers 1 positioned in their base 11 at the departure site, that is at the premises of the sender 2, and able to communicate data with the electronic cards 12 of the bases 11 on which the containers are positioned, and with the server centre 6. This programming and control device 7 of the containers 1 consists, for example, of a computer of the PC type, fitted with a flat touch screen and with communication resources of the Ethernet type.

It is quite obvious that the server centre 6 can be integrated into the programming and control resources 7 of the containers 1 without however moving outside the scope of the invention. Moreover, referring to FIG. 1, the system can include several programming and control resources 7,7′, etc. . . . , still without moving outside the scope of the invention.

In addition, referring to FIGS. 1 and 9, the system includes a vehicle 4 equipped with compartments 35 in which are positioned bases 11 whose electronic cards 12 are connected to each other so that the internal control resources 10 of the said containers 1 can exchange information. The said vehicle 4 includes a GPS system whose data are transmitted to the containers positioned in the compartments 35. Thus, when a carrier has to unload a container 1, it is necessary only to insert his memory card 9 into any of the containers 1 positioned in the compartments 35. The card reader 8 and the internal control resources 10 of the said container 1 then read the card bearing the information relating to the container or containers to be delivered, and transmit the said information to all of the other containers 1 positioned in the compartments 35. The container 1 which is to be delivered then indicates its presence by a light and/or audible signal for example. The carrier can then easily remove the container 1 from its compartment 35 if the position of the vehicle 4 supplied by the GPS system matched the trajectory recorded in the internal control resources of the said container 1.

Finally, it is quite obvious that the examples that have just been given are only particular illustrations, and are in no case limiting with regard to the area of application of the invention.

1. A secure system for the transportation or the conservation of valuables, in particular of banknotes, cheques, bank cards or similar, enclosed in a container (1) fitted with internal control resources (10) and resources (20, 21) for damaging the valuables in the event of an attack, with the said internal control resources (10) operating, for example, in the manner of a “limited modes machine” whose operating cycle includes a restricted number of logical states, called modes, with the transition from a first mode to a second mode being the result of a one-off event whose legitimacy is, or has been, verified beforehand by a server centre (6) located remotely, that is capable of making contact with the internal control resources (10) of the container (1) by any appropriate means, with the said transition then being accompanied by the loss of memory of the prior mode, characterised in that it is composed firstly of at least one container (1) fitted with a memory card (9) reader (8) connected to the internal control resources (10), with the said memory card (9) including in its memory at least one identity code of the user of the container (1), and secondly, of at least one base (11) fitted with an electronic card (12), the said card (12) being powered by an energy source, in which are recorded the data relating to the location of the said base (11), which is suitable to receive the container (1) fitted with a male or female connection resource connected to the internal control resources (10), mating with a complementary male or female connection resource (13) connected to the electronic card (12) of the base (11), so that a user can use the container (1) either in the manner of a permanent safe for the conservation of valuables, so that in order to open and close the container (1), he inserts the memory card (9) into the card reader (8) of the said container (1), which is then positioned on the base (11), so that opening and closing the container (1) is possible only if the data relating to the location of the base (11) are in agreement with the data recorded in the memory card (9) and/or in the internal control resources (10) of the container (1), either for transportation of the valuables from the localised fixed base (11) at a localised point of departure at the premises of the sender (2), to a second base (11) at the premises of the recipient (5).

2. A system according to claim 1 characterised in that the container (1) consists of a compartmented case (14), generally parallel-sided, equipped on its top surface with a carrying handle (15) and open at the front so that at least one drawer (16, 16a, 16b), forming a compartment in which the valuables are placed, is able to slide from a first closed position in which the said drawer (16, 16a, 16b) is located inside the compartmented case (14) to a second open position in which the said drawer (16, 16a, 16b) is located totally or partially outside the compartmented case (14).

3. A system according to claim 2 characterised in that the container (1) includes on its front side a slot for the insertion (17) of the memory card (9), located above the drawer (16, 16a, 16b), with the memory card (9) reader (8) connected to the internal control resources (10) located opposite to the slot (17) inside the compartmented case (14).

4. A system according to claim 3 characterised in that the container (1) includes, on its front side, a display screen (18) and control buttons (19) connected to the internal control resources (10) of the said container (1), located above the slot for introduction (17) of the memory card (9).

5. A system according to claim 2, characterised in that the resources (20, 21) for damaging the valuables consist of flexible pockets (20) filled with an indelible ink placed in the compartmented case (14) so that they are located above the valuables when the drawer (16, 16a, 16b) is closed, and designed to be torn by pyrotechnic resources (21) activated by the internal control resources (10) in the event of an attack.

6. A system according to claim 5 characterised in that it includes a DNA tracer mixed with the indelible ink.

7. A system according to claim 6 characterised in that the DNA tracer is specific to each container.

8. A system according to claim 1, characterised in that each container (1) includes a recording unit (22), called a black box, recording all the operations effected on the said container (1) between the base (11) of departure and the base (11) of arrival.

9. A system according to claim 8, characterised in that the recording unit (22) consists of an electronic memory component (EPROM)

10. A system according to claim 8, characterised in that the data saved in the recording unit (22) are totally erased when the container (1) is positioned on the base (11) of arrival.

11. A system according to claim 1, characterised in that the base (11) is composed of a rectangular horizontal plate (23) fitted with two longitudinal walls (24) and one lateral wall (25) forming the rear part of the said base (11).

12. A system according to claim 11 characterised in that the plate (23) includes, on its upper face, two parallel longitudinal rails (26) mating with two complementary longitudinal parallel grooves (27) located below the compartmented case (14) of the container (1).

13. A system according to claim 12, characterised in that the rails (26) include, on their respective top ends, a longitudinal contact (28) that bears against a stud (29), respectively positioned at the bottom of the grooves (27) of the compartmented case (14) of the container (1), with the contacts (28) and the studs (29) being connected to the energy source of the base (11) and to the power source of the internal control resources (10) of the container (1) respectively.

14. A system according to claim 11, characterised in that it includes a multiplicity of bases (11) attached to at least one vertical modular structure (30) including a generally rectangular horizontal base (31) onto which bears a first base (11), and from which extend three uprights (32) from the longitudinal walls (24) and the lateral wall (25) of the first base (11), with horizontal support platforms (33), capable of receiving a base (11) respectively, being fixed onto the uprights (32) at regular intervals.

15. A system according to claim 14, characterised in that the uprights (32) consist of tubular elements whose ends are designed to fit into lugs is extending from the upper face of the base (31) or on connecting pieces.

16. A system according to claim 1, characterised in that it includes device (7) for programming and control of the containers (1), where the latter are positioned in their bases (11) at the premises of the sender (2), capable of communicating data to the electronic cards (12) of the said bases (11) and to the server centre (6).

17. A system according to claim 16, characterised in that the programming and control device (7) of the containers (1) consist of a PC-type computer fitted with a flat touch screen and with communication resources.

18. A system according to claim 1, characterised in that it includes a vehicle (4) equipped with compartments (35) in which are placed bases (11) whose electronic cards (12) are connected to each other so that the internal control resources (10) of the said containers (10) can exchange information.

19. A system according to claim 18 characterised in that the vehicle (4) includes a GPS system whose data are transmitted to the containers (1) placed in the compartments (35).

20. A system according to claim 3, characterised in that the resources (20, 21) for damaging the valuables consist of flexible pockets (20) filled with an indelible ink placed in the compartmented case (14) so that they are located above the valuables when the drawer (16, 16a, 16b) is closed, and designed to be torn by pyrotechnic resources (21) activated by the internal control resources (10) in the event of an attack.
